(19) United States
(12) Patent Application Publication
(10) Pub. No.: US 2019/0304380 A1
(43) Pub. Date: Oct. 3, 2019

(54) METHOD FOR DRIVING DISPLAY DEVICE AND DEVICE FOR DRIVING SAME

(71) Applicants: HKC Corporation Limited, Shuitian Village, Shiyan Sub-district (CN); Chongqing HKC Optoelectronics Technology Co., Ltd., Chongqing (CN)

(72) Inventor: Chih-Tsung KANG, Chongqing (CN)

(21) Appl. No.: 16/064,410

(22) PCT Filed: Jan. 23, 2018
(86) PCT No.: PCT/CN2018/073765

§ 371 Date: Jun. 20, 2018

(30) Foreign Application Priority Data
Dec. 21, 2017 (CN) 201711394008.0

(51) Int. Cl. G09G 3/34; G09G 3/36

(52) U.S. Cl. CPC G09G 3/3413; G09G 3/3607; G09G 2320/029; G09G 2320/0626; G09G 2360/16

(57) ABSTRACT

This application relates to a method for driving a display device and a device for driving same. The method for driving a display device includes: calculating average signals of sub-pixel units in a zone to obtain a red average signal, a green average signal, and a blue average signal in the zone; determining, according to the average signals in the zone, which of a red hue, a green hue, and a blue hue is dominant in a lowest average signal sub-pixel that a minimum average signal belongs to; determining that a minimum signal of most pixel units in the zone is a hue of a sub-pixel of red, green, and blue; combining and distributing frame signals; and adjusting a backlight luminance.

### BACKGROUND

### Technical Field

This application relates to a method for designing a display panel, and in particular, to a method for driving a display device and a device for driving same.

### Related Art

A liquid-crystal display (LCD) is a flat thin display device, includes a quantity of color or black and white pixels, and is disposed in front of a light source or a reflecting surface. Each pixel includes the following parts: a liquid crystal molecular layer suspending between two transparent electrodes, and two polarization filters, with polarization directions perpendicular to each other, disposed on two outer sides. If there is no liquid crystal between electrodes, when light passes through one of the polarization filters, a polarization direction of the light is completely perpendicular to that of the second polarization filter. Therefore, the light is completely blocked. However, if the polarization direction of the light passing through one of the polarization filters is rotated by a liquid crystal, the light can pass through the other polarization filter. Rotation of the polarization direction of the light by the liquid crystal may be controlled by using an electrostatic field, so as to control the light.

Before charges are applied to transparent electrodes, arrangement of liquid crystal molecules is determined by arrangement on surfaces of the electrodes. Surfaces of chemical substances of the electrodes may be used as seeds of crystals. In a most common twisted nematic (TN) liquid crystal, two electrodes above and below the liquid crystal are vertically arranged. Liquid crystal molecules are arranged in a spiral manner. A polarization direction of light passing through one polarization filter rotates after the light passes through a liquid crystal sheet, so that the light can pass through the other polarization filter. In this process, a small part of light is blocked by the polarization filter, and looks gray when being seen from outside. After the charges are applied to the transparent electrodes, the liquid crystal molecules are almost completely arranged in parallel along an electric field direction. Therefore, a polarization direction of light passing through one of the polarization filters does not rotate. Therefore, the light is completely blocked. In this case, a pixel looks black. A twisting degree of arrangement of the liquid crystal molecules can be controlled by means of voltage control, so as to achieve different grayscales.

Because the liquid crystal itself is colorless, a color filter is used to generate various colors, and is a key component for turning a grayscale LCD into a color LCD. A backlight module in the LCD provides a light source, then grayscale display is formed by means of a drive IC and liquid crystal control, and the light source passes through a color photoresist layer of the color filter to form a color display image.

### SUMMARY

To resolve the foregoing technical problems, an objective of this application is to provide a method for designing a display panel, and in particular, a method for driving a display device, including: calculating average signals of sub-pixel units in a zone to obtain a first average signal, a second average signal, and a third average signal in the zone; determining, according to the average signals in the zone, which of a first hue, a second hue, and a third hue is dominant in a lowest average signal sub-pixel that a minimum average signal belongs to; determining that a minimum signal of most pixel units in the zone is a hue of a sub-pixel of a first color, a second color, and a third color; combining and distributing frame signals; and adjusting a backlight luminance.

To achieve the objective of this application and resolve technical problems of this application, the following technical solutions are used. A method for driving a display device provided in this application includes: calculating average signals of sub-pixel units in a zone to obtain a first average signal, a second average signal, and a third average signal in the zone; determining, according to the average signals in the zone, which of a first hue, a second hue, and a third hue is dominant in a lowest average signal sub-pixel that a minimum average signal belongs to; determining that a minimum signal of most pixel units in the zone is a hue of a sub-pixel of a first color, a second color, and a third color; combining and distributing frame signals; and adjusting a backlight luminance.

To further achieve the objective of this application and resolve technical problems of this application, the following technical measures may be taken.

Another objective of this application is to provide a device for driving a display device, including at least one zone, where each zone includes a plurality of pixel units, and each pixel unit includes a first sub-pixel unit, a second sub-pixel unit, and a third sub-pixel unit; and the device for driving a display device performs the following operations: calculating average signals of sub-pixel units in a zone to obtain a first average signal, a second average signal, and a third average signal in the zone; determining, according to the average signals in the zone, which of a first hue, a second hue, and a third hue is dominant in a lowest average signal sub-pixel that a minimum average signal belongs to; determining that a minimum signal of most pixel units in the zone is a hue of a sub-pixel of a first color, a second color, and a third color; combining and distributing frame signals; and adjusting a backlight luminance.

Still another objective of this application is to provide a device for driving a display device, including at least one zone, where each zone includes a plurality of pixel units, and each pixel unit includes a first sub-pixel unit, a second sub-pixel unit, and a third sub-pixel unit; and the device for driving a display device performs the following operations: calculating average signals of sub-pixel units in a zone to obtain a first average signal, a second average signal, and a third average signal in the zone; determining, according to the average signals in the zone, which of a first hue, a second hue, and a third hue is dominant in a lowest average signal sub-pixel that a minimum average signal belongs to; determining that a minimum signal of most pixel units in the zone is a hue of a sub-pixel of a first color, a second color, and a third color; combining and distributing frame signals; and adjusting a backlight luminance. Initial luminance signals of first, second, and third light sources in the zone are a first light source luminance, a second light source luminance, and a third light source luminance. A backlight luminance is improved to be three times its original backlight strength, that is, the backlight luminance is that a backlight first light source luminance is equal to 3*the first light source luminance, a backlight second light source luminance is equal to 3*the second light source luminance, and a backlight third light source luminance is equal to 3*the third light source luminance. However, if according to a first hue combination of the first average signal, the second average signal, and the third average signal of the average signals in the zone, assuming that there is a grayscale signal in which the first average signal is greater than the second average signal and the second average signal is greater than the third average signal, it indicates that a combination of a first pixel unit, a second pixel unit, and a third pixel unit of most sub-pixel units in the zone satisfies a law that the first pixel unit is greater than the second pixel unit and the second pixel unit is greater than the third pixel unit. Therefore, signals of most second third pixel units of a sub-pixel signal of a combination 2 of a second frame are 0, and the second frame displays only one sub-pixel color of a common sub-pixel signal of a difference between a first pixel unit, a second pixel unit, and a third pixel unit of an original signal and a signal of a frame 1. If the frame 2 displays a first sub-pixel signal using a difference signal, a sub-pixel second signal of the frame 2 is separately displayed in a frame 3. Therefore, the second and the third light sources of the backlight source are turned off when the second frame is displayed in the zone. Similarly, a sub-pixel signal of a combination 3 of the third frame displays only a second signal, and signals of a second first pixel unit and the second third pixel unit are 0. Therefore, the first and the third light sources of the backlight source are turned off when the third frame is displayed in the zone.

In an embodiment of this application, when the average signals of all pixel units in the zone are a first hue combination of the first average signal, the second average signal, and the third average signal, the first average signal is greater than the second average signal, and the second average signal is greater than the third average signal; and when a group of pixel units in the zone is a first hue combination of a first pixel unit, a second pixel unit, and a third pixel unit, and an order of values of a grayscale signal in which the first pixel unit is greater than the second pixel unit and the second pixel unit is greater than the third pixel unit is the same as an order of values of a grayscale signal, in which the first average signal is greater than the second average signal and the second average signal is greater than the third average signal, of the first hue combination of the average signals, that is, the first average signal, the second average signal, and the third average signal of the zone, a minimum common signal of the first pixel unit, the second pixel unit, and the third pixel unit of the sub-pixel unit is the third pixel unit.

In an embodiment of this application, the grayscale signal of the first pixel unit, the second pixel unit, and the third pixel unit of the sub-pixel unit is turned into a signal combination of three frames from a signal combination of one frame; and the three frames are respectively as follows: a frame 1 is a combination of a first first pixel unit, a first second pixel unit, and a first third pixel unit, a frame 2 is a combination of a second first pixel unit, a second second pixel unit, and a second third pixel unit, and a frame 3 is a combination of a third first pixel unit, a third second pixel unit, and a third third pixel unit, where the signal combination of the frame 1, the frame 2, and the frame 3 satisfies that a sum of the first first pixel unit, the second first pixel unit, and the third first pixel unit is equal to the first pixel unit, a sum of the first second pixel unit, the second second pixel unit, and the third second pixel unit is equal to the second pixel unit, and a sum of the first third pixel unit, the second third pixel unit, and the third third pixel unit is equal to the third pixel unit.

In an embodiment of this application, a combination 1 of the first first pixel unit, the first second pixel unit, and the first third pixel unit of a sub-pixel signal of the frame 1 uses a pixel signal of a minimum color third pixel unit, that is, the third pixel unit, of the sub-pixel unit as a common sub-pixel signal of the frame, that is, the first first pixel unit is equal to the third pixel unit, the first second pixel unit is equal to the third pixel unit, and the first third pixel unit is equal to the third pixel unit.

In an embodiment of this application, the second first pixel unit, the second second pixel unit, and the second third pixel unit of a sub-pixel signal of the frame 2 are a sub-pixel color of a common sub-pixel signal of a difference between a first pixel unit, a second pixel unit, and a third pixel unit of an original signal and a signal of the frame 1, that is, first, second, and third sub-pixel difference signals are respectively the first pixel unit−the third pixel unit, the second pixel unit−the third pixel unit, and 0, where when the frame 2 uses a first sub-pixel signal of the difference signals, a sub-pixel signal combination of the frame 2 is that the second first pixel unit is equal to the first pixel unit−the third pixel unit, the second second pixel unit is equal to 0, and the second third pixel unit is equal to 0.

In an embodiment of this application, the frame 3 is another sub-pixel second signal of the difference, and a sub-pixel signal combination of the frame 3 is that the third first pixel unit is equal to 0, the third second pixel unit is equal to the second pixel unit−the third pixel unit, and the third third pixel unit is equal to 0.

In an embodiment of this application, a sub-pixel signal of an original frame is turned into three frame grayscale combinations from the first pixel unit, the second pixel unit, and the third pixel unit, and the combination of three groups of frame signals is presented in a time sequence, where at one time, a frame combination 1 of the first first pixel unit, the first second pixel unit, and the first third pixel unit is presented; at another time, a frame combination 2 of the second first pixel unit, the second second pixel unit, and the second third pixel unit is presented; and at still another time, a frame combination 3 of the third first pixel unit, the third second pixel unit, and the third third pixel unit is presented.

In an embodiment of this application, a high-voltage sub-pixel signal is divided into two low-voltage combinations.

In this application, by means of determining signals of first, second, and third sub-pixel combinations, first, second, and third sub-pixel input signals in each group are divided into three frame signals for presentation, and in cooperation with the presentation, a drive frequency of a display needs to be tripled to separately display the three frame signals obtained by means of division. The three frame signals are respectively a minimum common signal frame, a second single color frame, and a third single color frame. The three frame signals obtained by means of division increase a luminance of a main tone at a side viewing angle, and increase a ratio of a main tone of the main sub-pixel relative to a side viewing angle luminance of an original frame low-voltage sub-pixel, so that a color cast situation, affected by the low-voltage sub-pixel, of the main tone at the side viewing angle is improved. Alleviation of a viewing angle color cast problem is ensured, and presentation of a main signal luminance at the side viewing angle is enhanced. A backlight luminance is enhanced to be three times of an original luminance, and therefore, a luminance of display of the first, the second, and the third sub-pixel combinations and overall image quality remain unchanged. According to a combination of the average signals in the zone, a second frame displays only a color other than a color of the minimum average signal in the zone. Most sub-pixel signals of sub-pixels of the second frame are 0, and most are of the color of the minimum average signal in the zone. Therefore, a color light source of first, second, and third light sources of a backlight source whose most sub-pixel signals are 0 may be turned off when the second frame is displayed in the zone. In addition, because the second frame displays only a combined signal of one color other than the color of the minimum average signal, the frame needs to display only a backlight signal of the color. Similarly, a third frame displays only a combined signal of a last color. Backlight luminance signals of different colors are provided to different frames, so as to save energy, and first, second, and third light source strength does not need to be enhanced to be three times its original luminance all the time, which has smallest impact on presentation of picture quality or images and has functions of energy saving and improvement of color casts.

### BRIEF DESCRIPTION OF THE DRAWINGS

FIG. 1 is a diagram of a relationship between a color system and a color cast of an exemplary LCD before color cast adjustment;

FIG. 2 is a diagram of a relationship between a red color cast and a grayscale of an LCD before color cast adjustment according to an embodiment of this application;

FIG. 3 is a diagram of a relationship between a green color cast and a grayscale of an LCD before color cast adjustment according to an embodiment of this application;

FIG. 4 is a diagram of a relationship between a blue color cast and a grayscale of an LCD before color cast adjustment according to an embodiment of this application;

FIG. 5 is a diagram of a relationship between red X, green Y, and blue Z of red, green, and blue at a front viewing angle and a grayscale of an LCD before color cast adjustment according to an embodiment of this application;

FIG. 6 is a diagram of a relationship between red X, green Y, and blue Z of red, green, and blue at a large viewing angle and a grayscale of an LCD before color cast adjustment according to an embodiment of this application;

FIG. 7 is a schematic diagram of a device for driving a display device according to an embodiment of this application; and

FIG. 8 is a flowchart of a method for driving a display device according to an embodiment of this application.

### DETAILED DESCRIPTION

The following embodiments are described with reference to the accompanying drawings, and are used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical measures taken in this application to achieve the intended application objective and effects thereof, specific implementations, structures, features, and effects of a method for driving a display device and a device for driving same provided according to this application are described in detail below with reference to the drawings and preferred embodiments.

A display device of this application includes a display panel and a backlight module disposed opposite to each other. The display panel mainly includes a color filter substrate, an active array substrate, and a liquid crystal layer sandwiched between the two substrates. The color filter substrate, the active array substrate, and the liquid crystal layer may form a plurality of pixel units arranged in an array. The backlight module may emit light rays penetrating through the display panel, and display colors by using pixel units of the display panel, to form an image.

In an embodiment, the display panel of this application may be a curved-surface display panel, and the display device of this application may also be a curved-surface display device.

Currently, in improvement of a wide viewing angle technology of a vertical alignment (VA) display panel, manufacturers of display devices have developed a photo-alignment technology to control an alignment direction of liquid crystal molecules, thereby improving optical performance and a yield of a display panel. In the photo-alignment technology, multi-domain alignment is formed in each pixel unit of a panel, so that liquid crystal molecules in a pixel unit tilt towards, for example, four different directions. In the photo-alignment technology, a polymer thin film (an alignment layer) of a color filter substrate or a thin film transistor substrate is irradiated by using an ultraviolet light source (for example, polarized light), so that non-homogeneous photopolymerization, isomerization, or pyrolysis occurs in polymer structures on a surface of the thin film, inducing chemical bond structures on the surface of the thin film to generate special directivities, so as to further induce forward arrangement of liquid crystal molecules, thereby performing photo-alignment.

According to different orientation manners of liquid crystals, currently, display panels on a mainstream market may be classified into the following types: a VA type, a TN or a super twisted nematic (STN) type, an in-plane switching (IPS) type, and a fringe field switching (FFS) type. Displays of a VA mode include, for example, a patterned vertical alignment (PVA) display or a multi-domain vertical alignment (MVA) display device. The PVA display achieves a wide viewing angle effect by using a fringe field effect and a compensation plate. In the MVA display device, one pixel is divided into a plurality of areas, and a protrusion or a particular pattern structure is used, so that liquid crystal molecules in different areas tilt towards different directions, to achieve a wide viewing angle and increase a penetration rate. In an IPS mode or an FFS mode, by applying an electric field including components approximately parallel to a substrate, liquid crystal molecules make responses in a direction parallel to a plane of the substrate and are driven. An IPS display panel and an FFS display panel have advantages of wide viewing angles.

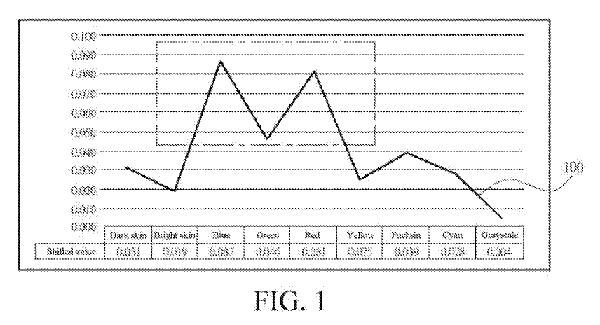

FIG. 1 is a diagram of a relationship between a color system and a color cast of an exemplary LCD before color cast adjustment. Referring to FIG. 1, in an LCD, due to a correlation between a refractive index and a wavelength, penetration rates of different wavelengths are related to phase delays of different wavelengths, so that penetration rates and wavelengths have performance of different degrees. In addition, with drive of a voltage, phase delays of different wavelengths also generate changes of different degrees, affecting performance of penetration rates of different wavelengths. FIG. 1 shows changes of color casts of large viewing angles and front viewing angles of various representative color systems of the LCD. It can be obviously found that situations of color casts 100 of large viewing angles of color systems of red, green, and blue hues are all more severe than those of other color systems. Therefore, overcoming color cast defects of the red, green, and blue hues can greatly improve an overall color cast of a large viewing angle.

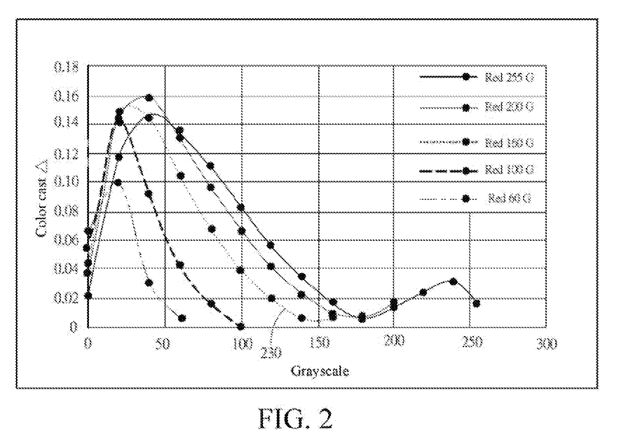

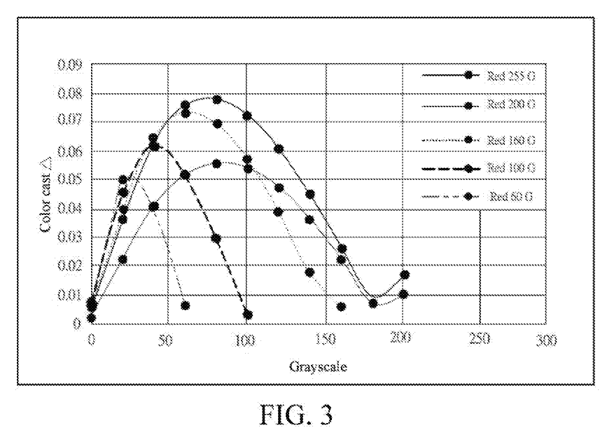

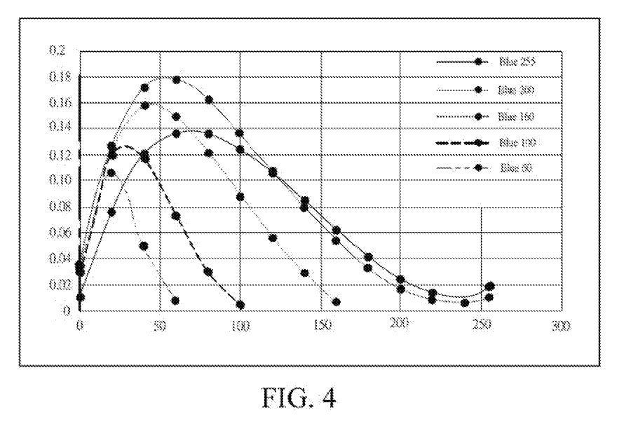

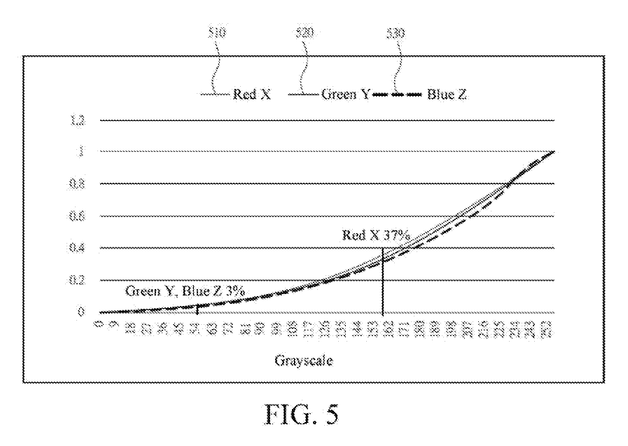

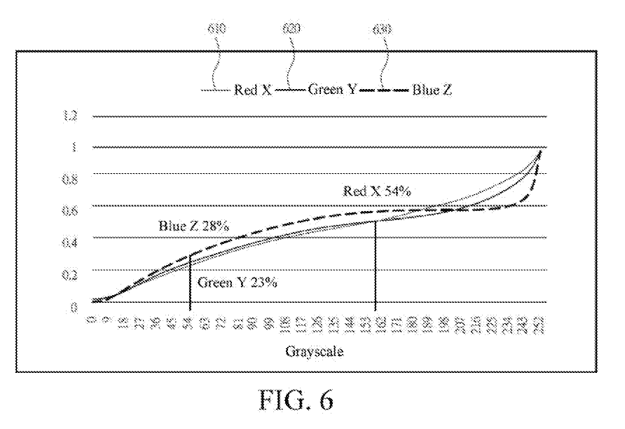

FIG. 2 is a diagram of a relationship between a red color cast and a grayscale of an LCD before color cast adjustment according to an embodiment of this application; FIG. 3 is a diagram of a relationship between a green color cast and a grayscale of an LCD before color cast adjustment according to an embodiment of this application; FIG. 4 is a diagram of a relationship between a blue color cast and a grayscale of an LCD before color cast adjustment according to an embodiment of this application; FIG. 5 is a diagram of a relationship between red X, green Y, and blue Z of red, green, and blue at a front viewing angle and a grayscale of an LCD before color cast adjustment according to an embodiment of this application; and FIG. 6 is a diagram of a relationship between red X, green Y, and blue Z of red, green, and blue at a large viewing angle and a grayscale of an LCD before color cast adjustment according to an embodiment of this application. Referring to FIG. 2, FIG. 3, and FIG. 4, FIG. 2 shows viewing angle color difference change situations of a front viewing angle and a 60-degree horizontal viewing angle under different color mixing conditions of a green system. As for a color cast change of a red hue combination, when a grayscale of a red curve 230 is 160, color mixing of red hues refers to that when green and blue signals are smaller than a red signal or are quite small relative to a red signal, with increases in differences between green and red signals and between blue and red signals, a viewing angle color cast situation is gradually severe. Similarly, as for a color cast change of a green hue combination in FIG. 3, with increases in differences between red and green signals and between blue and green signals, a viewing angle color cast situation is gradually severe. As for a color cast change of a blue hue combination in FIG. 4, with increases in differences between red and blue signals and between green and blue signals, a viewing angle color cast situation is gradually severe.

Refer to FIG. 5, FIG. 6, and the following descriptions for reasons of a color cast. For example, a grayscale of a mixed color at a front viewing angle is red 160, green 50, and blue 50; and grayscale ratios of red X510, green Y520, and blue Z530 to full grayscales red 255, green 255, and blue 255 at a corresponding front viewing angle are 37%, 3%, and 3% in color mixing, and grayscale ratios of red X610, green Y620, and blue Z630 to full grayscales red 255, green 255, and blue 255 at a corresponding large viewing angle are 54%, 23%, and 28% in color mixing. Ratios of red X, green Y, and blue Z in the mixed color at the front viewing angle are different from those of red X, green Y, and blue Z in a mixed color at the large viewing angle. Consequently, luminance ratios of the green Y and the blue Z to the red X at the original front viewing angle are considerably small, and luminance ratios of the green Y and the blue Z to the red X at the large viewing angle are non-neglectable. As a result, a red hue at the large viewing angle is not as bright as a red hue at the front viewing angle, and an obvious color cast occurs.

Referring to the description of FIG. 2, as for color cast changes of various red hue combinations, with increases of differences between green and red signals and between blue and red signals, a viewing angle color cast situation is gradually severe. The reason is, as stated above in FIG. 5 and FIG. 6, that the luminance ratios 37%, 3%, and 3% of red, green, and blue at the front viewing angle are greatly different from the luminance ratios 54%, 23%, and 28% of red, green, and blue at the large viewing angle. In addition, a lower grayscale signal indicates a larger difference between a front viewing angle luminance and a side viewing angle luminance because of rapid saturation and improvement of the viewing angle luminance ratios of grayscale liquid crystal display. An existing international nation-suggested color cast value may have a relatively good liquid crystal display viewing angle observation feature when a color difference≤0.02. In this application, by changing an original frame signal to a multi-frame combination, luminance differences between mixed colors of red, green, and blue at the front viewing angle and at the side viewing angle are reduced, to present picture quality of low color cast display.

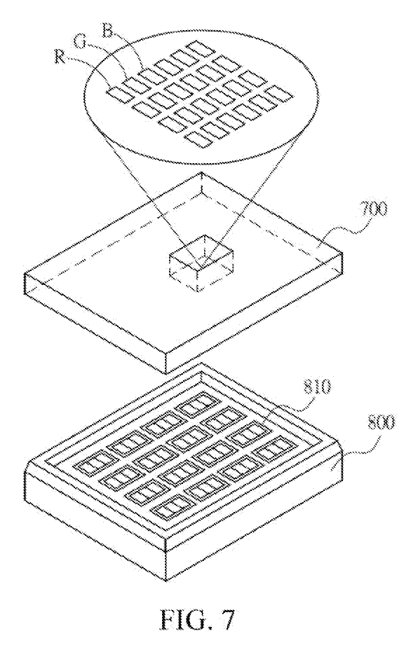

FIG. 7 is a schematic diagram of a device for driving a display device according to an embodiment of this application. Referring to FIG. 7, in an embodiment of this application, a device 800 for driving a display device includes a plurality of red, green, and blue sub-pixels. Each group of red, green, and blue sub-pixels is referred to as a pixel unit 810. Each pixel unit 810 represents an image signal. In this application, a backlight source of red, green, and blue light-emitting diodes is divided into a plurality of zones. Each zone 700 includes a plurality of pixel units. Sizes of the zones may be self-defined. The backlight source and a display may be divided into a plurality of zones in columns*rows (N*M), and each zone has independent red, green, and blue light-emitting diode light sources. The device for driving a display device in this application performs the following operations: calculating average signals of sub-pixel units in a zone 700 to obtain a red average signal, a green average signal, and a blue average signal in the zone; determining, according to the average signals in the zone, which of a red hue, a green hue, and a blue hue is dominant in a lowest average signal sub-pixel that a minimum average signal belongs to; determining that a minimum signal of most pixel units in the zone is a hue of a sub-pixel of red, green, and blue; combining and distributing frame signals; and adjusting a backlight luminance.

Referring to FIG. 7, in an embodiment, the device 800 for driving a display device includes at least one zone 700. Each zone 700 includes a plurality of pixel units, and each pixel unit 810 includes a red sub-pixel unit, a green sub-pixel unit, and a blue sub-pixel unit. The device 800 for driving a display device performs the following operations: calculating average signals of sub-pixel units in the zone 700 to obtain a red average signal, a green average signal, and a blue average signal in the zone; determining, according to the average signals in the zone, which of a red hue, a green hue, and a blue hue is dominant in a lowest average signal sub-pixel that a minimum average signal belongs to; determining that a minimum signal of most pixel units in the zone is a hue of a sub-pixel of red, green, and blue; combining and distributing frame signals; and adjusting a backlight luminance. Initial luminance signals of red, green, and blue light sources in the zone are a red light source luminance, a green light source luminance, and a blue light source luminance. A backlight luminance is improved to be three times its original backlight strength, that is, the backlight luminance is that a backlight red light source luminance is equal to 3*the red light source luminance, a backlight green light source luminance is equal to 3*the green light source luminance, and a backlight blue light source luminance is equal to 3*the blue light source luminance. However, if according to a red hue combination of the red average signal, the green average signal, and the blue average signal of the average signals in the zone, assuming that there is a grayscale signal in which the red average signal is greater than the green average signal and the green average signal is greater than the blue average signal, it indicates that a combination of a red pixel unit, a green pixel unit, and a blue pixel unit of most sub-pixel units in the zone satisfies a law that the red pixel unit is greater than the green pixel unit and the green pixel unit is greater than the blue pixel unit. Therefore, signals of most second blue pixel units of a sub-pixel signal of a combination 2 of a second frame are 0, and the second frame displays only one sub-pixel color of a common sub-pixel signal of a difference between a red pixel unit, a green pixel unit, and a blue pixel unit of an original signal and a signal of a frame 1. If the frame 2 displays a red sub-pixel signal using a difference signal, a sub-pixel green signal of the frame 2 is separately displayed in a frame 3. Therefore, the green and the blue light sources of the backlight source are turned off when the second frame is displayed in the zone. That is, A′n,m_G is equal to 0, and A′n,m_B is equal to 0. Similarly, a sub-pixel signal of a combination 3 of the third frame displays only a green signal, and signals of a second red pixel unit and the second blue pixel unit are 0. Therefore, the red and the blue light sources of the backlight source are turned off when the third frame is displayed in the zone. That is, A′n,m_R is equal to 0, and A′n,m_B is equal to 0.

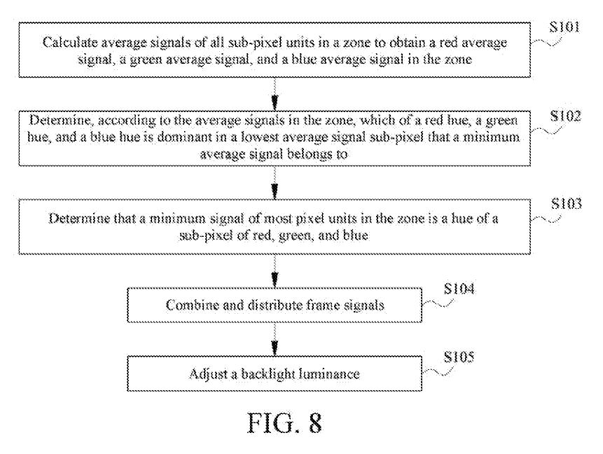

FIG. 8 is a flowchart of a method for driving a display device according to an embodiment of this application. Referring to FIG. 8, in an embodiment of this application, a method for driving a display device includes: calculating average signals of sub-pixel units in a zone to obtain a red average signal, a green average signal, and a blue average signal in the zone; determining, according to the average signals in the zone, which of a red hue, a green hue, and a blue hue is dominant in a lowest average signal sub-pixel that a minimum average signal belongs to; determining that a minimum signal of most pixel units in the zone is a hue of a sub-pixel of red, green, and blue; combining and distributing frame signals; and adjusting a backlight luminance.

In an embodiment, when the average signals of all pixel units in the zone are a red hue combination of the red average signal, the green average signal, and the blue average signal, the red average signal is greater than the green average signal, and the green average signal is greater than the blue average signal; and when a group of pixel units in the zone is a red hue combination of a red pixel unit, a green pixel unit, and a blue pixel unit, and an order of values of a grayscale signal in which the red pixel unit is greater than the green pixel unit and the green pixel unit is greater than the blue pixel unit is the same as an order of values of a grayscale signal, in which the red average signal is greater than the green average signal and the green average signal is greater than the blue average signal, of the red hue combination of the average signals, that is, the red average signal, the green average signal, and the blue average signal of the zone, a minimum common signal of the red pixel unit, the green pixel unit, and the blue pixel unit of the sub-pixel unit is the blue pixel unit.

In an embodiment, the grayscale signal of the red pixel unit, the green pixel unit, and the blue pixel unit of the sub-pixel unit is turned into a signal combination of three frames from a signal combination of one frame; and the three frames are respectively as follows: a frame 1 is a combination of a first red pixel unit, a first green pixel unit, and a first blue pixel unit, a frame 2 is a combination of a second red pixel unit, a second green pixel unit, and a second blue pixel unit, and a frame 3 is a combination of a third red pixel unit, a third green pixel unit, and a third blue pixel unit, where the signal combination of the frame 1, the frame 2, and the frame 3 satisfies that a sum of the first red pixel unit, the second red pixel unit, and the third red pixel unit is equal to the red pixel unit, a sum of the first green pixel unit, the second green pixel unit, and the third green pixel unit is equal to the green pixel unit, and a sum of the first blue pixel unit, the second blue pixel unit, and the third blue pixel unit is equal to the blue pixel unit.

In an embodiment, a combination 1 of the first red pixel unit, the first green pixel unit, and the first blue pixel unit of a sub-pixel signal of the frame 1 uses a pixel signal of a minimum color blue pixel unit, that is, the blue pixel unit, of the sub-pixel unit as a common sub-pixel signal of the frame, that is, the first red pixel unit is equal to the blue pixel unit, the first green pixel unit is equal to the blue pixel unit, and the first blue pixel unit is equal to the blue pixel unit.

In an embodiment, the second red pixel unit, the second green pixel unit, and the second blue pixel unit of a sub-pixel signal of the frame 2 are a sub-pixel color of a common sub-pixel signal of a difference between a red pixel unit, a green pixel unit, and a blue pixel unit of an original signal and a signal of the frame 1, that is, red, green, and blue sub-pixel difference signals are respectively the red pixel unit−the blue pixel unit, the green pixel unit−the blue pixel unit, and 0, where when the frame 2 uses a red sub-pixel signal of the difference signals, a sub-pixel signal combination of the frame 2 is that the second red pixel unit is equal to the red pixel unit−the blue pixel unit, the second green pixel unit is equal to 0, and the second blue pixel unit is equal to 0.

In an embodiment, the frame 3 is another sub-pixel green signal of the difference, and a sub-pixel signal combination of the frame 3 is that the third red pixel unit is equal to 0, the third green pixel unit is equal to the green pixel unit−the blue pixel unit, and the third blue pixel unit is equal to 0.

In an embodiment, a sub-pixel signal of an original frame is turned into three frame grayscale combinations from the red pixel unit, the green pixel unit, and the blue pixel unit, and the combination of three groups of frame signals is presented in a time sequence, where at one time, a frame combination 1 of the first red pixel unit, the first green pixel unit, and the first blue pixel unit is presented; at another time, a frame combination 2 of the second red pixel unit, the second green pixel unit, and the second blue pixel unit is presented; and at still another time, a frame combination 3 of the third red pixel unit, the third green pixel unit, and the third blue pixel unit is presented.

In an embodiment, a high-voltage sub-pixel signal is divided into two low-voltage combinations.

Referring to FIG. 8, flow S101: Calculate average signals of sub-pixel units in a zone to obtain a red average signal, a green average signal, and a blue average signal in the zone.

Referring to FIG. 8, flow S102: Determine, according to the average signals in the zone, which of a red hue, a green hue, and a blue hue is dominant in a lowest average signal sub-pixel that a minimum average signal belongs to.

Referring to FIG. 8, flow S103: Determine that a minimum signal of most pixel units in the zone is a hue of a sub-pixel of red, green, and blue.

Referring to FIG. 8, flow S104: Combine and distribute frame signals.

Referring to FIG. 8, flow S105: Adjust a backlight luminance.

In an embodiment, a red hue combination of sub-pixel units R_{i,j}, G_{i,j}, and B_{i,j} (i,j indicates a group of R, G, and B pixel units in a display area) in the display area when, for example, R_{i,j}=100, G_{i,j}=80, and B_{i,j}=40, is calculated. A minimum common signal of R_{i,j}, G_{i,j}, and B_{i,j} has a grayscale of 40. Therefore, a grayscale signal of R_{i,j}, G_{i,j}, and B_{i,j} is changed into three combinations, and the three combinations are respectively a combination 1 of R1_{i,j}, G1_{i,j}, and B1_{i,j}, a combination 2 of R2_{i,j}, G2_{i,j}, and B2_{i,j}, and a combination 3 of R3_{i,j}, G3_{i,j}, and B3_{i,j}. A minimum common signal of the combination 1 of R1_{i,j}, G1_{i,j}, and B1_{i,j} has a grayscale of 40, that is, R1_{i,j}=40, G1_{i,j}=40, and B1_{i,j}=40. The combination 2 of R2_{i,j}, G2_{i,j}, and B2_{i,j} is one color of a difference between an original signal and a signal of the combination 1. As described above, the combination 2 may satisfy that R2_{i,j}=60, G2_{i,j}=0, and B2_{i,j}=0 or R2_{i,j}=0, G2_{i,j}=40, and B2_{i,j}=0. The combination 3 is a last remaining signal color, that is, R3_{i,j}=0, G3_{i,j}=40, and B3_{i,j}=0 or R3_{i,j}=60, G3_{i,j}=0, and B3_{i,j}=0. Except that the combination 1 is the common signal, a color order of the combinations 2 and 3 may be preferentially presented by any color of the remaining signal.

In an embodiment, the original sub-pixel signal is changed from R_{i,j}, G_{i,j}, and B_{i,j} into a combination of three frame signals, and the combination of the three frame signals is presented in a time sequence. That is, the original frame signal needs to be tripled. At one time, the combination 1 of R1_{i,j}, G1_{i,j}, and B1_{i,j} is presented; at another time, the combination 2 of R2_{i,j}, G2_{i,j}, and B2_{i,j} is presented; and at still another time, the combination 3 of R3_{i,j}, G3_{i,j}, and B3_{i,j} is presented.

Referring to FIG. 5 and FIG. 6, in an embodiment, assuming that front viewing angle luminance ratios of the original frame signal R_{i,j}=100, G_{i,j}=80, and B_{i,j}=40 to a full grayscale signal Gray 255 are SR %, LG %, and MB %, and side viewing angle luminance ratios are correspondingly SR′%, LG′%, and MB′%, where SR>LG>MB, and SR′>LG′>MB′. However, as stated above, a lower grayscale signal indicates a larger difference between a front viewing angle luminance and a side viewing angle luminance. That is, it can be learned that SR/MB is greater than SR′/MB′, and LG/MB is greater than LG′/MB′. Such color mixing makes a luminance of a main luminance signal SR at the front viewing angle greatly different from that of an MB signal, but a luminance of a main luminance signal SR′ at the large viewing angle is slightly different from that of an MB′ signal. Consequently, a viewing angle main tone color is affected and color brightness is decreased. Referring to FIG. 5, SR %=13.3%, LG %=8%, and MB=1.8%. Referring to FIG. 6, SR′%=40%, LG′%=33%, and MB′=17%.

Referring to FIG. 5 and FIG. 6, in an embodiment, a frame combination is used. In the combination 1 of R1_{i,j}, G1_{i,j}, and B1_{i,j}, because signals all have a grayscale of 40, it may be assumed that in FIG. 5, front viewing angle luminance ratios of R1_{i,j}, G1_{i,j}, and B1_{i,j} in the frame are 1.8%, 1.8%, and 1.8%. In FIG. 6, side viewing angle luminance ratios are correspondingly 17%, 17%, and 17%. In FIG. 5, front viewing angle luminance ratios of the combination 2 of R2_{i,j}=60, G2_{i,j}=0, and B2_{i,j}=0 in the frame are 3.8%, 0%, and 0%. In FIG. 6, side viewing angle luminance ratios are correspondingly 26.8%, 0%, and 0%. In FIG. 5, front viewing angle luminance ratios of the combination 3 of R2_{i,j}=0, G2_{i,j}=40, and B2_{i,j}=0 in the frame are 0%, 1.8%, and 0%. In FIG. 6, side viewing angle luminance ratios are correspondingly 0%, 17%, and 0%. Color mixing ratios of the frame 1, the frame 2, and the frame 3 at the side viewing angle, that is, R_{i,j}:G_{i,j}:B_{i,j}, are 17%+26.8%+0%=43.8%, 17%+0%+17%=34%, and 17%+0%+0%=17%. Side viewing angle luminance ratios of the original frame, that is, R_{i,j}:G_{i,j}:G_{i,j}, are 38%, 30%, and 17%. Obviously, a main tone R is increased from 40/17=2.35 in the original frame to 43.8/17=2.57 of the combined frame relative to the luminance ratio of B. A ratio of a main tone pixel is obviously increased compared with other tones. Therefore, a viewing angle is presented in a manner of approaching a main tone from the front viewing angle.

In an embodiment, other sub-pixel unit combinations R′i,j, G′i,j, and B′i,j (i and j are one group of R, G, and B pixel units in the display area) exist in the zone, for example, a green hue combination when R′i,j=A2, G′i,j=B2, and B′i,j=C2. It is assumed that a grayscale signal in which B2>C2>C2 has a value order different from that of a grayscale signal in which A is greater than B and B is greater than C in a red hue combination of the average signals, that is, Ave_Rn,m=A, Ave_Gn,m=B, and Ave_Bn,m=C, of the zone.

In an embodiment, a minimum common signal of R′_{i,j}, G′_{i,j}, and B′_{i,j} is, for example, A2. The grayscale signal of the sub-pixel units R′_{i,j}, G′_{i,j}, and B′_{i,j} is turned into three grayscale frames, and the three grayscale frames are respectively a frame combination 1 of R′1_{i,j}, G′1_{i,j} and B′1_{i,j} a frame combination 2 of R′2_{i,j}, G′2_{i,j}, and B′2_{i,j}, and a frame combination 3 of R′3_{i,j}, G′3_{i,j}, and B′3_{i,j}. The signal combination of the frame 1, the frame 2, and the frame 3 satisfies that R′1_{i,j}+R′2_{i,j}+R′3_{i,j}=R′_{i,j}, G′1_{i,j}+G′2_{i,j}+G′3_{i,j}=G′_{i,j}, and B′1_{i,j}+B′3_{i,j}=B′_{i,j}. The combination 1 of R′1_{i,j}, G′ 1_{i,j} and B′1_{i,j} uses a minimum color R′_{i,j} pixel signal A2 of the sub-pixel unit as a common sub-pixel signal of the frame, that is, R′1_{i,j}G′1_{i,j}=A2, and B′1_{i,j}=A2. The sub-pixel signals R2_{i,j}, G2_{i,j}, and B2_{i,j} of the frame 2 are a sub-pixel color of a common sub-pixel signal of a difference between R_{i,j}, G_{i,j}, and B_{i,j} of an original signal and the signal of the frame 1, that is, R, G, and B sub-pixel difference signals are respectively 0, B2−A2, and C2−A2. The frame 2 uses one sub-pixel signal of the difference signals, and the frame 3 uses another sub-pixel signal of the difference. If the frame 2 uses a red sub-pixel signal of the difference signals, a sub-pixel signal combination of the frame 2 is R2_{i,j}=0, G2_{i,j}=0, and B2_{i,j}=C2−A2. The frame 3 is another sub-pixel green signal of the difference, and a sub-pixel signal combination of the frame 3 is R3_{i,j}=0, G2_{i,j}=B2−A2, and B2_{i,j}=0.

In an embodiment, in a red hue combination of Ave_R_{n,m}=A, Ave_G_{n,m}=B, and Ave_B_{n,m}=C in the average signals in a zone, combinations of most sub-pixels in the zone are all grayscale signals satisfying that R′_{i,j}>G′_{i,j}>B′_{i,j}, and a combination of signals of R1_{i,j}=A1, G1_{i,j}=B1, and B1_{i,j}=C1 of the frame 1 of most sub-pixel units in the zone is a minimum common signal C1. Therefore, signals of most B2_{i,j} of sub-pixels of the combination of the second frame are 0, and the frame displays only a sub-pixel color of the common sub-pixel signal of the difference between R_{i,j}, G_{i,j}, and B_{i,j} of the original signal and the signal of the frame 1. If the frame 2 displays a red sub-pixel signal using the difference signals, a sub-pixel green signal of the frame 2 is separately displayed in the frame 3. Therefore, when the second frame is displayed in the zone, green and blue light-emitting diode light sources of the backlight source are turned off. In this way, a signal of B′2_{i,j}=C2−A2 of a frame combination 2 of a green hue combination (B2>C2>A2) of R′_{i,j}=A2, G′_{i,j}=B2, and B′_{i,j}=C2 described above of the signal cannot pass through a blue light-emitting diode light source to be normally presented when the sub-pixel in the zone does not satisfy that R′_{i,j}>G′_{i,j}>B′_{i,j}. However, it can be predicted that the average signals in the zone are a red hue combination of Ave_R_{n,m}=A, Ave_G_{n,m}=B, and Ave_B_{n,m}=C. Most sub-pixel combinations are grayscale signals in which A is greater than B and B is greater than C, and other combination situations in the zone are relatively few. Therefore, the second frame signal of the sub-pixel does not present a small number of B′_{i,j}, and compensation signals do not have much impact on an overall color or picture quality. The sub-pixel signal of the combination 3 of the third frame displays only a green signal, and signals of G2_{i,j} and B2_{i,j} are 0. Therefore, red and blue light emitting diode light sources of the backlight source may be turned off when the third frame is displayed in the zone.

In this application, by means of determining signals of red, green, and blue sub-pixel combinations, red, green, and blue sub-pixel input signals in each group are divided into three frame signals for presentation, and in cooperation with the presentation, a drive frequency of a display needs to be tripled to separately display the three frame signals obtained by means of division. The three frame signals are respectively a minimum common signal frame, a second single color frame, and a third single color frame. The three frame signals obtained by means of division increase a luminance of a main tone at the side viewing angle, and increase a ratio of a main tone of the main sub-pixel relative to the side viewing angle luminance of the original frame low-voltage sub-pixel, so that a color cast situation, affected by the low-voltage sub-pixel, of the main tone at the side viewing angle is improved. Alleviation of a viewing angle color cast problem is ensured, and presentation of a main signal luminance at the side viewing angle is enhanced. A backlight luminance is enhanced to be three times of an original luminance, and therefore, a luminance of display of the red, the green, and the blue sub-pixel combinations and overall image quality remain unchanged. According to a combination of the average signals in the zone, a second frame displays only a color other than a color of the minimum average signal in the zone. Most sub-pixel signals of sub-pixels of the second frame are 0, and most are of the color of the minimum average signal in the zone. Therefore, a color light source of red, green, and blue light sources of a backlight source whose most sub-pixel signals are 0 may be turned off when the second frame is displayed in the zone. In addition, because the second frame displays only a combined signal of one color other than the color of the minimum average signal, the frame needs to display only a backlight signal of the color. Similarly, the third frame displays only a combined signal of a last color. Backlight luminance signals of different colors are provided to different frames, so as to save energy, and red, green, and blue light source strength does not need to be enhanced to be three times its original luminance all the time, which has smallest impact on presentation of picture quality or images and has functions of energy saving and improvement of color casts.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

The foregoing descriptions are merely preferred embodiments of this application, and are not intended to limit this application in any form. Although this application has been disclosed above through the preferred embodiments, the embodiments are not intended to limit this application. Any person skilled in the art can make some variations or modifications, which are equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A method for driving a display device, comprising:
calculating average signals of sub-pixel units in a zone to obtain a first average signal, a second average signal, and a third average signal in the zone;
determining, according to the average signals in the zone, which of a first hue, a second hue, and a third hue is dominant in a lowest average signal sub-pixel that a minimum average signal belongs to;
determining that a minimum signal of most pixel units in the zone is a hue of a sub-pixel of a first color, a second color, and a third color;
combining and distributing frame signals; and
adjusting a backlight luminance.

2. The method for driving a display device according to claim 1, wherein when the average signals of all pixel units in the zone are a first hue combination of the first average signal, the second average signal, and the third average signal, the first average signal is greater than the second average signal, and the second average signal is greater than the third average signal.

3. The method for driving a display device according to claim 2, wherein when a group of pixel units in the zone is a first hue combination of a first pixel unit, a second pixel unit, and a third pixel unit, and an order of values of a grayscale signal in which the first pixel unit is greater than the second pixel unit and the second pixel unit is greater than the third pixel unit is the same as an order of values of a grayscale signal, in which the first average signal is greater than the second average signal and the second average signal is greater than the third average signal, of the first hue combination of the average signals, that is, the first average signal, the second average signal, and the third average signal of the zone, a minimum common signal of the first pixel unit, the second pixel unit, and the third pixel unit of the sub-pixel unit is the third pixel unit.

4. The method for driving a display device according to claim 2, wherein the grayscale signal of the first pixel unit, the second pixel unit, and the third pixel unit of the sub-pixel unit is turned into a signal combination of three frames from a signal combination of one frame.

5. The method for driving a display device according to claim 4, wherein the three frames are respectively as follows: a frame 1 is a combination of a first first pixel unit, a first second pixel unit, and a first third pixel unit, a frame 2 is a combination of a second first pixel unit, a second second pixel unit, and a second third pixel unit, and a frame 3 is a combination of a third first pixel unit, a third second pixel unit, and a third third pixel unit.

6. The method for driving a display device according to claim 5, wherein the signal combination of the frame 1, the frame 2, and the frame 3 satisfies that a sum of the first first pixel unit, the second first pixel unit, and the third first pixel unit is equal to the first pixel unit, a sum of the first second pixel unit, the second second pixel unit, and the third second pixel unit is equal to the second pixel unit, and a sum of the first third pixel unit, the second third pixel unit, and the third third pixel unit is equal to the third pixel unit.

7. The method for driving a display device according to claim 6, wherein a combination 1 of the first first pixel unit, the first second pixel unit, and the first third pixel unit of a sub-pixel signal of the frame 1 uses a pixel signal of a minimum color third pixel unit, that is, the third pixel unit, of the sub-pixel unit as a common sub-pixel signal of the frame, that is, the first first pixel unit is equal to the third pixel unit, the first second pixel unit is equal to the third pixel unit, and the first third pixel unit is equal to the third pixel unit.

8. The method for driving a display device according to claim 6, wherein the second first pixel unit, the second second pixel unit, and the second third pixel unit of a sub-pixel signal of the frame 2 are a sub-pixel color of a common sub-pixel signal of a difference between a first pixel unit, a second pixel unit, and a third pixel unit of an original signal and a signal of the frame 1, that is, first, second, and third sub-pixel difference signals are respectively the first pixel unit−the third pixel unit, the second pixel unit−the third pixel unit, and 0.

9. The method for driving a display device according to claim 8, wherein when the frame 2 uses a first sub-pixel signal of the difference signals, a sub-pixel signal combination of the frame 2 is that the second first pixel unit is equal to the first pixel unit−the third pixel unit, the second second pixel unit is equal to 0, and the second third pixel unit is equal to 0.

10. The method for driving a display device according to claim 6, wherein the frame 3 is another sub-pixel second signal of the difference, and a sub-pixel signal combination of the frame 3 is that the third first pixel unit is equal to 0, the third second pixel unit is equal to the second pixel unit−the third pixel unit, and the third third pixel unit is equal to 0.

11. The method for driving a display device according to claim 1, wherein a sub-pixel signal of an original frame is turned into three frame grayscale combinations from the first pixel unit, the second pixel unit, and the third pixel unit, and the combination of three groups of frame signals is presented in a time sequence.

12. The method for driving a display device according to claim 11, wherein at one time, a frame combination 1 of the first first pixel unit, the first second pixel unit, and the first third pixel unit is presented.

13. The method for driving a display device according to claim 12, wherein at another time, a frame combination 2 of the second first pixel unit, the second second pixel unit, and the second third pixel unit is presented.

14. The method for driving a display device according to claim 13, wherein at still another time, a frame combination 3 of the third first pixel unit, the third second pixel unit, and the third third pixel unit is presented.

15. The method for driving a display device according to claim 1, wherein a high-voltage sub-pixel signal is divided into two low-voltage combinations.

16. A device for driving a display device, comprising at least one zone, wherein each zone comprises a plurality of pixel units, and each pixel unit comprises a first sub-pixel unit, a second sub-pixel unit, and a third sub-pixel unit; and the device for driving a display device performs the following operations:
calculating average signals of sub-pixel units in a zone to obtain a first average signal, a second average signal, and a third average signal in the zone;
determining, according to the average signals in the zone, which of a first hue, a second hue, and a third hue is dominant in a lowest average signal sub-pixel that a minimum average signal belongs to;
determining that a minimum signal of most pixel units in the zone is a hue of a sub-pixel of a first color, a second color, and a third color;
combining and distributing frame signals; and
adjusting a backlight luminance.

17. The device for driving a display device according to claim 16, wherein when the average signals of all pixel units in the zone are a first hue combination of the first average signal, the second average signal, and the third average signal, the first average signal is greater than the second average signal, and the second average signal is greater than the third average signal; when a group of pixel units in the zone is a first hue combination of a first pixel unit, a second pixel unit, and a third pixel unit, and an order of a grayscale signal in which the first pixel unit is greater than the second pixel unit and the second pixel unit is greater than the third pixel unit is the same as an order of values of a grayscale signal, in which the first average signal is greater than the second average signal and the second average signal is greater than the third average signal, of the first hue combination of the average signals, that is, the first average signal, the second average signal, and the third average signal of the zone, a minimum common signal of the first pixel unit, the second pixel unit, and the third pixel unit of the sub-pixel unit is the third pixel unit.

18. The device for driving a display device according to claim 17, wherein the grayscale signal of the first pixel unit, the second pixel unit, and the third pixel unit of the sub-pixel unit is turned into a signal combination of three frames from a signal combination of one frame; and the three frames are respectively as follows: a frame 1 is a combination of a first first pixel unit, a first second pixel unit, and a first third pixel unit, a frame 2 is a combination of a second first pixel unit, a second second pixel unit, and a second third pixel unit, and a frame 3 is a combination of a third first pixel unit, a third second pixel unit, and a third third pixel unit.

19. The device for driving a display device according to claim 16, wherein a high-voltage sub-pixel signal is divided into two low-voltage combinations.

20. A device for driving a display device, comprising at least one zone, wherein each zone comprises a plurality of pixel units, and each pixel unit comprises a first sub-pixel unit, a second sub-pixel unit, and a third sub-pixel unit; and the device for driving a display device performs the following operations:
calculating average signals of sub-pixel units in a zone to obtain a first average signal, a second average signal, and a third average signal in the zone;
determining, according to the average signals in the zone, which of a first hue, a second hue, and a third hue is dominant in a lowest average signal sub-pixel that a minimum average signal belongs to;
determining that a minimum signal of most pixel units in the zone is a hue of a sub-pixel of a first color, a second color, and a third color;
combining and distributing frame signals; and
adjusting a backlight luminance, wherein
a sub-pixel signal of an original frame is turned into three frame grayscale combinations from the first pixel unit, the second pixel unit, and the third pixel unit, and the combination of three groups of frame signals is presented in a time sequence; at one time, a frame combination 1 of the first first pixel unit, the first second pixel unit, and the first third pixel unit is presented; at another time, a frame combination 2 of the second first pixel unit, the second second pixel unit, and the second third pixel unit is presented; and at still another time, a frame combination 3 of the third first pixel unit, the third second pixel unit, and the third third pixel unit is presented.
